(19) United States
(12) Patent Application Publication
(10) Pub. No.: US 2015/0022856 A1
(43) Pub. Date: Jan. 22, 2015

(54) IMAGE PROCESSING APPARATUS, METHOD FOR CONTROLLING IMAGE PROCESSING APPARATUS, AND PROGRAM

(71) Applicant: CANON KABUSHIKI KAISHA, Tokyo (JP)

(72) Inventor: Hidetaka Nakahara, Kawasaki-shi (JP)

(21) Appl. No.: 14/332,117

(22) Filed: Jul. 15, 2014

(30) Foreign Application Priority Data
Jul. 17, 2013 (JP) 2013-148472

(51) Int. Cl. G06F 3/12

(52) U.S. Cl. CPC G06F 3/1247; G06F 3/1285
USPC 358/1.15

(57) ABSTRACT

An image processing apparatus is capable of communicating with a server that can generate print data. In the image processing apparatus, first data is transmitted to the server when the first data is in a format that cannot be processed in the image processing apparatus. Print processing of second data is executed ahead of the first data, when the second data received after the first data is in a format which can be processed in the image processing apparatus and the first data is in a state of being converted.

### BACKGROUND

1. Field

Aspects of the present invention generally relate to an image processing apparatus that communicates with a server apparatus or an information processing apparatus. The present invention also relates to a method for controlling an image processing apparatus, and a program.

2. Description of the Related Art

Conventionally, upon accepting designation of a print target file, an image processing apparatus transmits the print target file to an image processing server (a server apparatus). The image processing server converts the received file into print data that can be interpreted by the image processing apparatus. The image processing apparatus then performs printing based on the print data converted by the image processing server. Such a known technique is discussed, for example, in Japanese Patent Application Laid-Open No. 2011-131382. This technique enables the image processing apparatus to print a file in a format that cannot be interpreted by the image processing apparatus.

However, in the technique of Japanese Patent Application Laid-Open No. 2011-131382, the image processing apparatus is in a processing waiting state, while the image processing server converts the print target file into the print data. Therefore, for example, even if there is a job for which processing can be completed by the image processing apparatus alone, the image processing apparatus waits for completion of the processing by the image processing server and thus cannot process a subsequent job efficiently.

### SUMMARY

According to an aspect of the present invention, an image forming apparatus includes a transmission unit configured to transmit first data to the server, when the first data is in a format which cannot be processed in the image processing apparatus; and an execution unit configured to execute print processing of second data ahead of the first data, when the second data received after the first data is in a format which can be processed in the image processing apparatus and the first data processed by the server is not received.

Further features of the present disclosure will become apparent from the following description of exemplary embodiments with reference to the attached drawings.

### BRIEF DESCRIPTION OF THE DRAWINGS

FIG. 1 is a diagram illustrating an example of an image forming system to which an image processing apparatus is applied.

FIG. 2 is a block diagram illustrating an example of a configuration of an image processing server illustrated in FIG. 1.

FIG. 3 is a block diagram illustrating an example of a configuration of the image processing apparatus illustrated in FIG. 1.

FIG. 4 is a block diagram illustrating software modules of a controller.

FIGS. 5A and 5B are a flowchart used to describe a method for controlling the image processing apparatus.

FIG. 6 is a diagram used to describe processing for changing a job execution sequence.

FIG. 7 is a diagram used to describe a condition for changing a job execution sequence in job-sequence changing processing.

FIGS. 8A to 8D are diagrams each illustrating an example of a user interface (UI) screen that can be displayed in the image processing apparatus.

FIG. 9 is a flowchart used to describe a method for controlling an image processing apparatus.

### DESCRIPTION OF THE EMBODIMENTS

Various exemplary embodiments will be described in detail below with reference to the drawings.

### Description of System Configuration

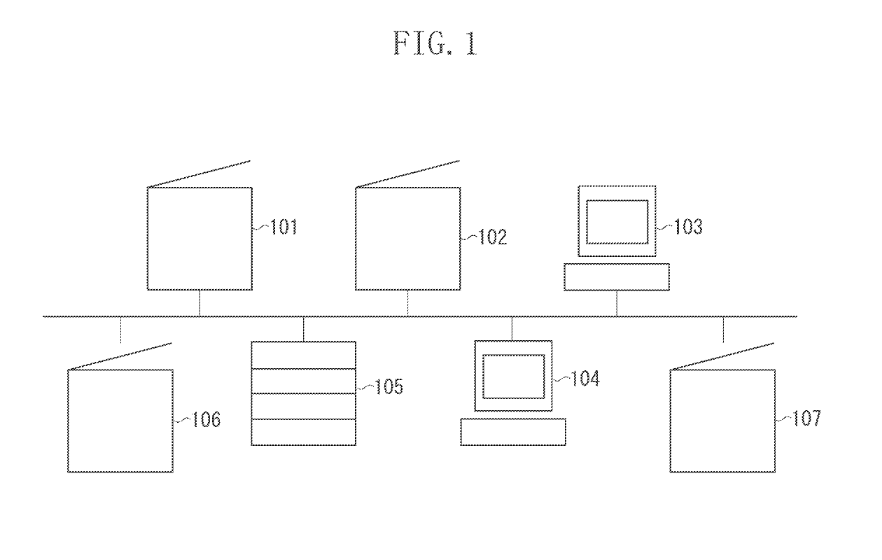

FIG. 1 is a diagram illustrating an example of an image forming system to which an image processing apparatus according to a first exemplary embodiment is applied. The image forming system of this example includes one or more image processing apparatuses including image processing apparatuses 101, 102, 106, and 107. The image forming system of this example further includes information processing terminals (information processing apparatuses) 103 and 104, as well as an image processing server 105 that performs image processing. These apparatuses are communicably connected by a network. Here, it is assumed that the image processing server 105 is adapted to a cloud computing environment. In addition, the image processing apparatuses may have the same or different processing capacities. For example, exemplary embodiments are applicable to an environment where an image processing apparatus capable of color image output and an image processing apparatus capable of monochrome image output are combined.

The image processing apparatuses will be described below by taking the image processing apparatus 101 as a representative example. It is to be noted that the network mentioned here may be of any type including a local area network (LAN) and the Internet, as long as the network enables mutual communication between the apparatuses in the image forming system.

The image processing apparatus 101 can receive a request for printing a print target file from the information processing terminal 103, and print an image based on the received request. Further, the image processing apparatus 101 can read an image of a document by using a scanner provided in the image processing apparatus 101, and can also print the read image.

In addition, the image processing apparatus 101 can provide a user with contents of a server message block (SMB) shared folder in the information processing terminal 103 or 104, as well as contents of a Universal Serial Bus (USB) memory connected to the image processing apparatus 101. The image processing apparatus 101 can print a print target file selected from these contents by the user. Further, when a print target file cannot be processed by itself, the image processing apparatus 101 can request the image processing server 105 to convert the print target file into print data. For example, when unable to interpret a received print target file, the image processing apparatus 101 transmits a request for conversion of the print target file, to the image processing server 105. In response to this request for conversion, the image processing server 105 converts the print target file into print data (such as a page-description language (PDL), and converted image data) that can be interpreted by the image processing apparatus 101. The image processing server 105 then returns the print data to the image processing apparatus 101. This processing allows print processing to continue. Therefore, the image processing server 105 can be referred to as an apparatus capable of generating print data.

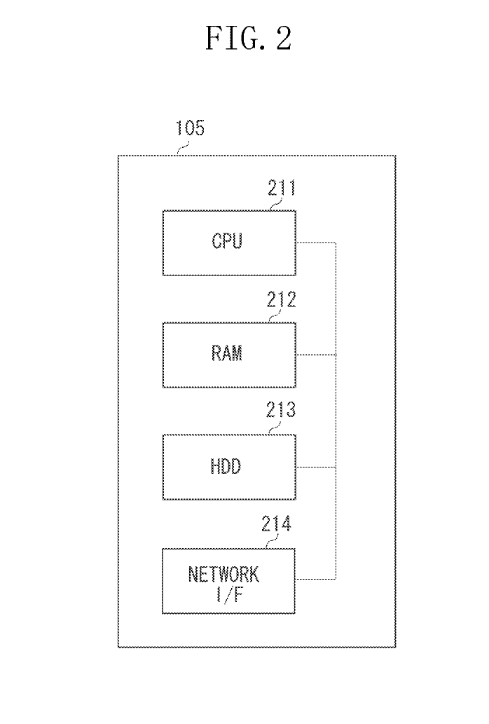

Upon receipt of processing-details instruction data and processing target data (the print target file) from the image processing apparatus 101, the image processing server 105 performs the instructed processing on the processing target data. The image processing server 105 then returns the print data to the image processing apparatus 101 that is a request source. FIG. 2 is a block diagram illustrating an example of a configuration of the image processing server 105 illustrated in FIG. 1.

The image processing server 105 includes a CPU 211, a RAM 212, a HDD 213, and a network interface (I/F) 214. The CPU 211 controls the entire image processing server 105, and can control transmission and reception of data to and from the RAM 212, the HDD 213, and the network I/F 214. In addition, the CPU 211 reads a control program (a command) from the HDD 213, expands the read control program in the RAM 212, and executes the command stored in the RAM 212.

The HDD 213 stores a control program (a command) executable by the CPU 211 and used to implement exemplary embodiments of the present disclosure. This unique processing will be described below. In addition, the HDD 213 can appropriately store data received from the image processing apparatus 101. This data includes, for example, information about a file format processable by the image processing server 105, processing-details instruction data, and processing target data. The RAM 212 allows expansion of the command stored in the HDD 213, and enables the CPU 211 to read the expanded command. The RAM 212 can store various kinds of data necessary for execution of the command.

The network I/F 214 is provided to perform network communication with the apparatuses in the image forming system. The network I/F 214 informs the CPU 211 of data reception, and transmits data on the RAM 212 to the network.

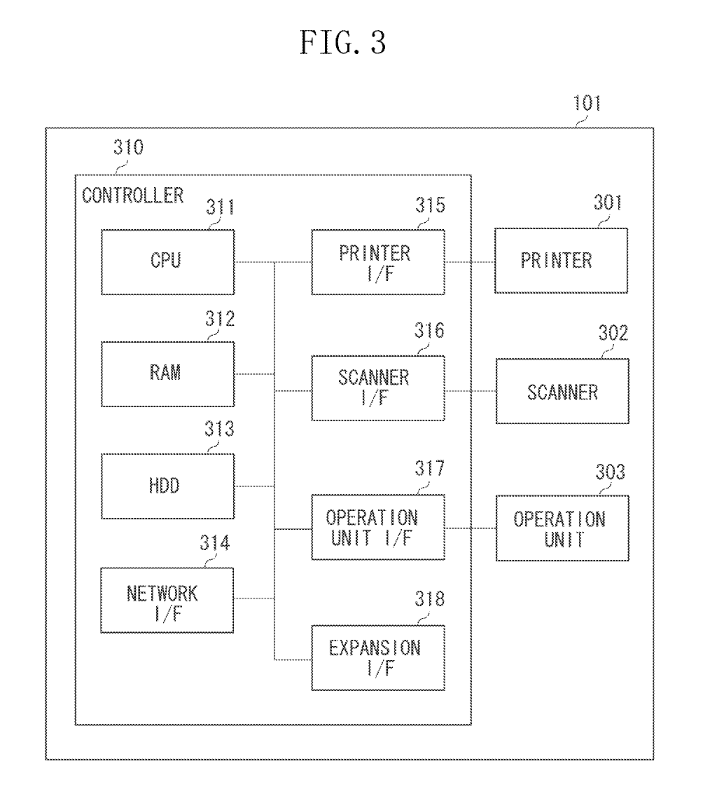

FIG. 3 is a block diagram illustrating an example of a configuration of the image processing apparatus 101 illustrated in FIG. 1. In FIG. 3, the image processing apparatus 101 includes a controller 310, a printer 301, a scanner 302, and an operation unit 303. The controller 310 includes a CPU 311, a RAM 312, a HDD 313, a network I/F 314, a printer I/F 315, a scanner I/F 316, an operation unit I/F 317, and an expansion I/F 318.

The CPU 311 can transmit and receive data to and from the RAM 312, the HDD 313, the network I/F 314, the printer I/F 315, the scanner I/F 316, and the operation unit I/F 317. In addition, the CPU 311 reads a command from the HDD 313, expands the read command in the RAM 312, and executes the command stored in the RAM 312.

The HDD 313 can store, for example, a command executable by the CPU 311, a set value to be used in the image processing apparatus 101, and data about processing requested by a user. The RAM 312 allows expansion of the command stored in the HDD 313, and enables the CPU 311 to read the expanded command. The RAM 312 can store various kinds of data necessary for execution of the command.

The network I/F 314 is provided to perform network communication with the apparatuses in the image forming system. The network I/F 314 informs the CPU 311 of data reception, and transmits data on the RAM 312 to the network. The printer I/F 315 transmits, to the printer 301, image data transmitted from the CPU 311. The printer I/F 315 also transmits, to the CPU 311, a printer status obtained from the printer 301.

The scanner I/F 316 transmits, to the scanner 302, an image reading instruction transmitted from the CPU 311. Further, the scanner I/F 316 transmits, to the CPU 311, image data received from the scanner 302, and informs the CPU 311 of a status received from the scanner 302.

The operation unit I/F 317 transmits, to the CPU 311, an instruction input by a user through the operation unit 303. The operation unit I/F 317 also transmits screen information for operation by the user to the operation unit 303.

The printer 301 performs printing on a sheet based on image data received from the printer I/F 315, and informs the printer I/F 315 of a printer status.

The scanner 302 follows an image reading instruction received from the scanner I/F 316. According to the instruction, the scanner 302 reads information on a sheet placed on the scanner 302, converts the information into digital data, and transmits the digital data to the scanner I/F 316. Further, the scanner 302 transmits a status (for example, the number of read pages, and/or detected jams (overlap feeding)) of the scanner 302 to the scanner I/F 316. The scanner 302 has a function of reading both sides of a document by a single scan. The scanner 302 can also print the both sides on one page based on processing by the CPU 311.

The operation unit 303 accepts an instruction provided from the user to the image processing apparatus 101. For example, the operation unit 303 includes a liquid crystal display (LCD) screen having a touch panel to provide an operation screen to the user, and accepts operation of the user.

The expansion I/F 318 allows connection of an external device to the image processing apparatus 101. For example, a USB-format I/F may be provided so that data can be read from and written to a connected external storage device such as a USB memory.

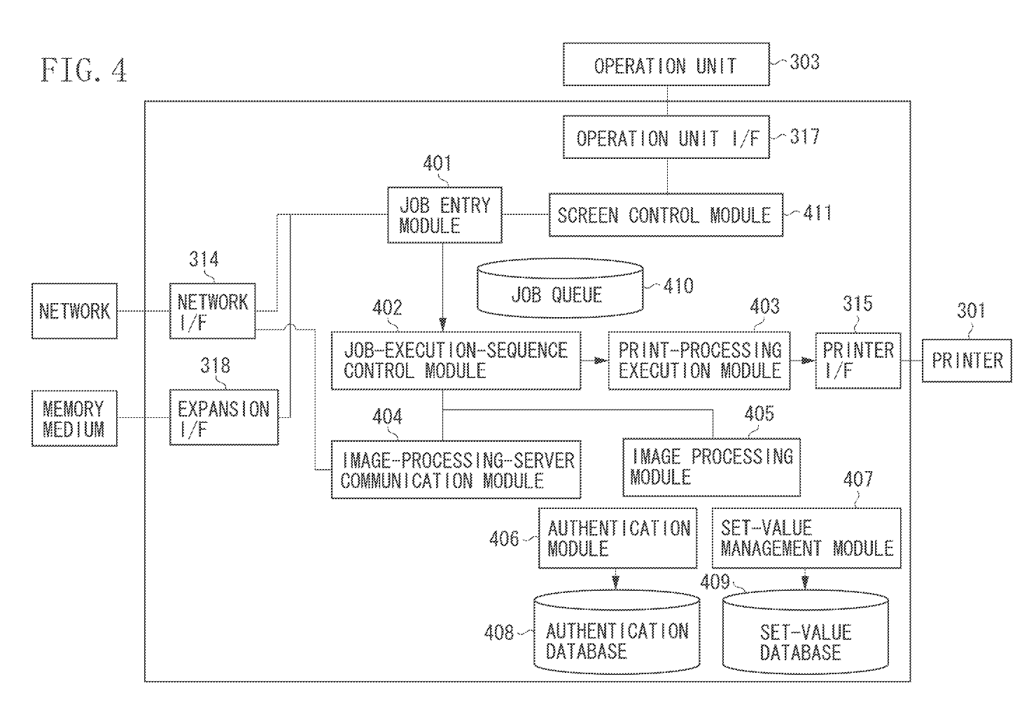

FIG. 4 is a block diagram illustrating software modules of the controller 310 illustrated in FIG. 3.

In FIG. 4, the controller 310 includes a job entry module 401, a job-execution-sequence control module 402, a print-processing execution module 403, an image-processing-server communication module 404, an image processing module 405, and a screen control module 411. Further, the controller 310 includes a job queue 410 that spools information of one or more jobs. In addition, the controller 310 includes an authentication module 406 and an authentication database 408, as a management module and a data storage to be managed by the management module, respectively. Similarly, the controller 310 includes a set-value management module 407 and a set-value database 409, as a management module and a data storage to be managed by the management module, respectively.

There are two entry modes for entry of a print target file. In a first entry mode, the print target file is fed from, for example, a USB memory (or a secure digital (SD) memory) connected through the expansion I/F 318. It is to be noted that the print target file to be fed may be merely referred to as data. Through the operation unit I/F 317, the screen control module 411 causes the operation unit 303 to display the print target file stored in the USB memory. The user then selects the print target file and instructs printing of the selected print target file, through the operation unit 303. The job entry module 401 obtains the selected print target file from the USB memory through the expansion I/F 318, and generates a job.

In a second entry mode, the print target file is received through the network I/F 314. For example, the print target file is received from the information processing terminal 103 or 104, through a printer driver. Alternatively, the print target file on a network storage such as SMB may be displayed on the operation screen in a manner similar to that in the case of using the USB memory. The job entry module 401 may then obtain the print target file selected by the user, and generate a job.

In this case, the job entry module 401 receives the print target file through the network I/F 314, and generates the job.

The job generated in either of these two modes is sent to the job-execution-sequence control module 402 as a print job. The job-execution-sequence control module 402 determines whether processing of the print job utilizes the image processing server 105.

If printing of the print job can be completed in the image processing apparatus 101, the job-execution-sequence control module 402 instructs the image processing module 405 to perform conversion to an image. Subsequently, the job-execution-sequence control module 402 requests the print-processing execution module 403 to perform processing. The print-processing execution module 403 then instructs the printer 301 through the printer I/F 315, to print the image.

On the other hand, when the image processing apparatus 101 cannot interpret the received print target file, the image processing apparatus 101 requests the image processing server 105 to perform data conversion processing, and waits for completion of this processing. Specifically, the image-processing-server communication module 404 requests the image processing server 105 through the network I/F 314 to perform the processing, and receives a result of the processing (this result may be referred to as converted image data or print data). The job-execution-sequence control module 402 then requests the print-processing execution module 403 to perform processing of the converted image data received from the image processing server 105. The print-processing execution module 403 then instructs the printer 301 through the printer I/F 315, to perform printing based on this image data.

The authentication module 406 performs user management in the image processing apparatus 101. Specifically, by utilizing user information stored in the authentication database 408, the authentication module 406 performs authentication for the operation unit 303 and authentication processing for entry through the network. By utilizing the information, the job entry module 401 allows a job to hold owner information indicating who provided the job.

Further, the set-value management module 407 manages the set-value database 409 that stores set values defining behaviors of the image processing apparatus 101. The authentication database 408 and the set-value database 409 are stored in a nonvolatile storage such as the HDD 313.

When a job is fed successively, the job-execution-sequence control module 402 sequentially adds the job to the job queue 410. The job-execution-sequence control module 402 has a function of optimally dividing the processing after adding the job to the job queue 410. Specifically, the processing is divided, in consideration of availability of execution resources of the image-processing-server communication module 404, the image processing module 405, and the print-processing execution module 403, as well as the status of a job waiting for execution. The job queue 401 is stored in a volatile region such as the RAM 312.

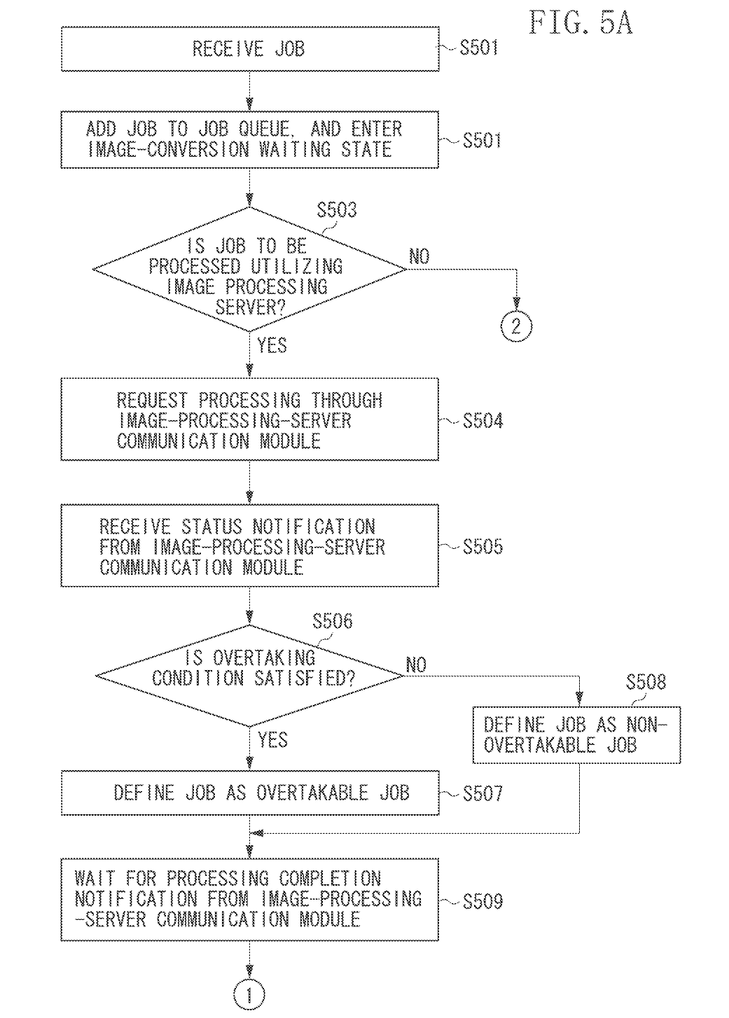

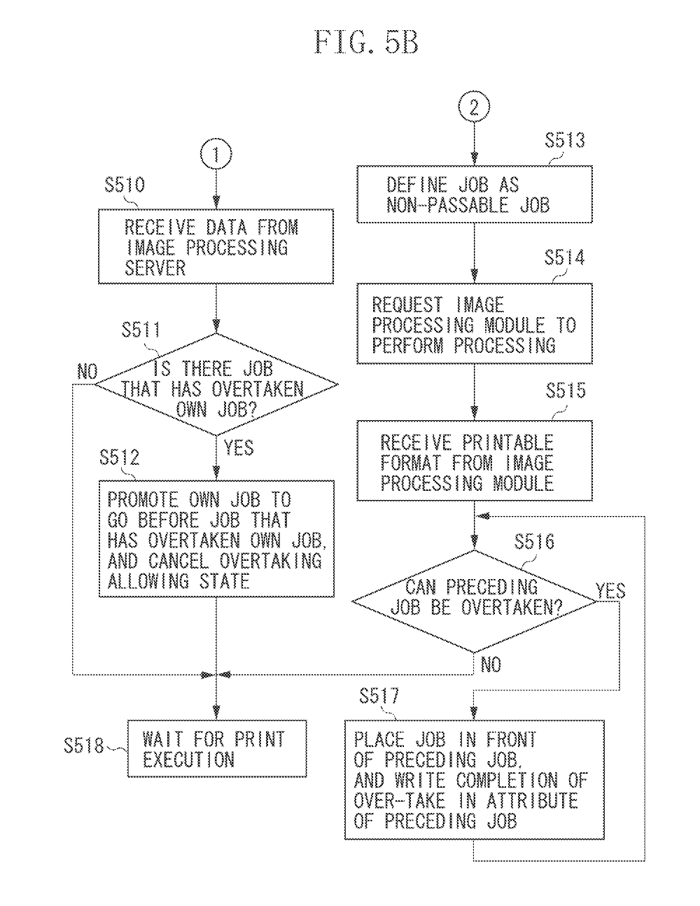

FIGS. 5A and 5B are a flowchart used to describe a method for controlling the image processing apparatus 101 according to the present exemplary embodiment. This is an example of execution sequence control by the job-execution-sequence control module 402 that is illustrated in FIG. 4 and executed by the CPU 311 illustrated in FIG. 3. To be more specific, FIGS. 5A and 5B illustrates an example of processing from job entry into the job-execution-sequence control module 402 by the job entry module 401, to a print execution state. In the print execution state, the print-processing execution module 403 can perform processing for a processing target job. Each step of this flowchart is implemented, when the CPU 311 executes the control program stored in the HDD 313 after loading the control program into the RAM 312. The flowchart will be described below, using each of the modules illustrated in FIG. 4, as a subject.

In step S501, the job-execution-sequence control module 402 receives a processing target job from the job entry module 401. In step S502, the job-execution-sequence control module 402 adds the processing target job to the end of the job queue 410. Subsequently, in step S503, the job-execution-sequence control module 402 determines whether the processing target job is a job to be subjected to image processing in the image processing apparatus 101, or a job which the image processing apparatus 101 requests the image processing server 105 to process. For example, based on information such as the extension of the processing target job, the job-execution-sequence control module 402 determines whether this job is in a format that cannot be processed in the image processing apparatus 101. When the job is in a format that cannot be processed, the job-execution-sequence control module 402 determines that this job is a job which the image processing apparatus 101 requests the image processing server 105 to process (Yes in step S503). When Yes in step S503, the job-execution-sequence control module 402 then proceeds to step S504. In step S504, through the image-processing-server communication module 404, the job-execution-sequence control module 402 requests the image processing server 105 to perform the processing. Actually, data related to the processing target job is transmitted to the image processing server 105. Subsequently, in step S505, the job-execution-sequence control module 402 receives a result of initial communication of the image-processing-server communication module 404 with the image processing server 105. As will be described below, necessary information to be received in this step is information necessary for interchange of a job execution sequence such as success or failure of communication with the image processing server 105, and presence or absence of necessary data in the image processing server 105.

Subsequently, in step S506, based on the result of the initial communication and a device status in the job, the job-execution-sequence control module 402 determines whether an overtaking condition is satisfied. Specific examples of a criterion for this determination will also be described below. Here, when it is determined that the overtaking is allowed (Yes in step S506), the job-execution-sequence control module 402 proceeds to step S507, and sets a overtakability attribute in the processing target job.

However, when it is determined that the overtaking is not allowed (No in step S506), the job-execution-sequence control module 402 proceeds to step S508. In step S508, the job-execution-sequence control module 402 sets a non-overtakability attribute in the processing target job. Subsequently, in step S509, the job-execution-sequence control module 402 enters a state of waiting for a conversion result from the image processing server 105.

In step S510, the job-execution-sequence control module 402 receives converted image data from the image processing server 105, through the image-processing-server communication module 404. Subsequently, in step S511, the job-execution-sequence control module 402 determines whether a job in a waiting state which precedes the processing target job is present on the job queue 410. When it is determined that such a preceding job is not present (No in step S511), the job-execution-sequence control module 402 proceeds to step S518. In step S518, the processing target job enters a print waiting state in which the image processing apparatus is ready to begin the printing as soon as printer resources become available.

On the other hand, when it is determined that a preceding job waiting for printing is present (Yes in step S511), the job-execution-sequence control module 402 proceeds to step S512. In step S512, the job-execution-sequence control module 402 interchanges the jobs in the execution sequence in the job queue 410. In this step, since information about a job that has overtaken the processing target job is described in a job attribute (to be described below), the job-execution-sequence control module 402 interchanges the jobs in the execution sequence so that the processing target job is processed before the job described in the job attribute. It is to be noted that the processing target job is not allowed to overtake a job that originally precedes the processing target job at the time of the entry of the processing target job. In addition, when this re-promotion occurs, the overtakability attribute is being set in the processing target job and therefore, this overtakability attribute is canceled, and a print execution sequence is fixed. The job-execution-sequence control module 402 then proceeds to step S518, and waits for execution of the print processing. This is job processing that utilizes the image processing server 105.

When it is determined that the job does not utilize the image processing server 105 (No in step S503), the job-execution-sequence control module 402 proceeds to step S513. In step S513, the job-execution-sequence control module 402 sets a non-overtakability attribute in the processing target job that does not utilize the image processing server 105. Subsequently, in step S514, the job-execution-sequence control module 402 requests the image processing module 405 in the image processing apparatus 101 to perform image processing on the processing target job. Next, in step S515, the image processing module 405 receives converted printable data. In step S516, the job-execution-sequence control module 402 then determines whether a job with an overtakability attribute is present immediately before the processing target job. When a job with an overtakability attribute is present (Yes in step S516), then in step S517, the job-execution-sequence control module 402 places the processing target job in front of the job with the overtakability attribute, in the job queue 410. Further, job information about the overtaking job is written in the attribute of the overtaken job.

The job-execution-sequence control module 402 then returns to step S516, to repeat the processing for determining whether the processing target job can overtake an immediately preceding job. The job-execution-sequence control module 402 then executes the processing for changing the job execution sequence in step S517, when a result in step S516 is Yes. The job-execution-sequence control module 402 continues this loop until there is no preceding job or there is a preceding job that cannot be overtaken. When determination in step S516 is No, the job-execution-sequence control module 402 proceeds to step S518, and waits for execution of the print processing.

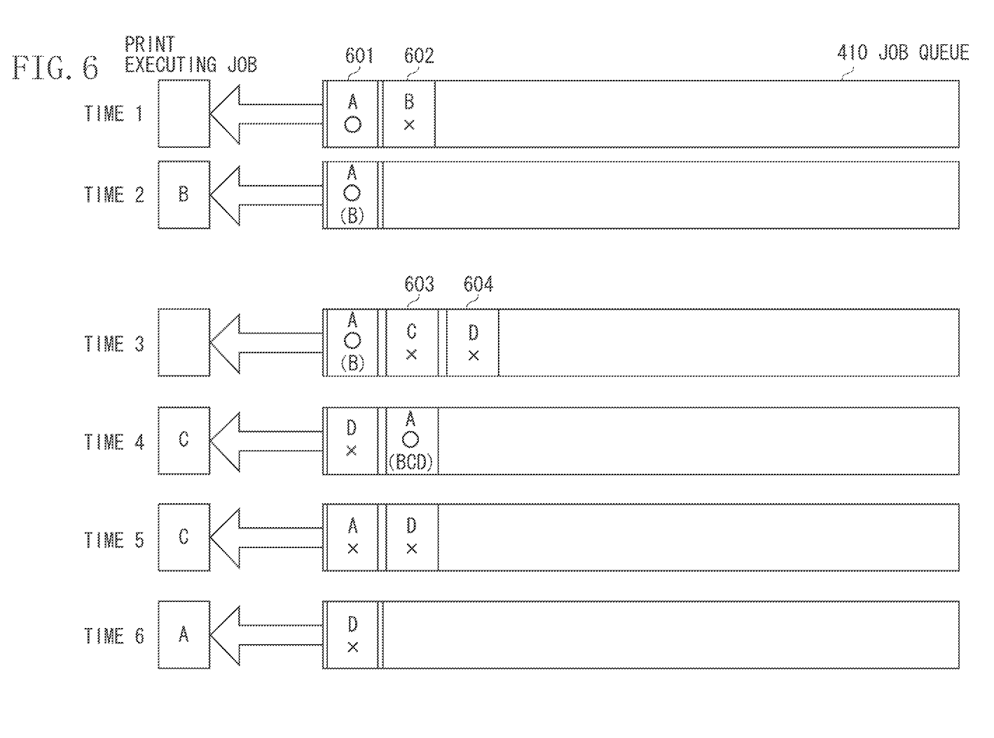

FIG. 6 is a diagram describing the processing for changing the job execution sequence by the job-execution-sequence control module 402 illustrated in FIG. 4. FIG. 6 schematically illustrates how sequence control in the job queue 410 is performed in a time series fashion. Each example of job-execution sequence control will be described below based on the processing illustrated in FIGS. 5A and 5B.

In FIG. 6, a job 601 (a job A) is assumed to utilize the image processing server 105, and satisfy the overtaking condition in step S506. The job 601 is provided with “o” indicating that this job can be overtaken. A job 602 (a job B) is assumed not to utilize the image processing server 105. The job 602 is provided with “x” indicating non-overtakability.

For example, in a state at a time 1, the job B is fed when the job A is in a state of waiting to receive converted image data from the image processing server 105 (step S509). The state at the time 1 is maintained in the job queue 410. Subsequently, at a time 2 when the job B is in a printable state in step S515, interchange of the jobs in the execution sequence in step S517 occurs, and printing for the job B is performed ahead of the job A. At the same time, information “(B)” indicating that the job B has overtaken the job A is written in the job A.

In that state, at a time 3, a job 603 (a job C provided with “x” indicating non-overtakability) and a job 604 (a job D provided with “x” indicating non-overtakability) that do not utilize the image processing server 105 are fed successively. The job A is in the overtakable state. Therefore, the processing order of these subsequent jobs is changed in step S517 when these jobs become printable.

In a state at a time 4, the orders of the jobs C and D are both changed in step S517, and printing for the job C is performed ahead of the job A. Job information C and D indicating that the jobs C and D have overtaken the job A is added to the job A.

In a state at a time 5, the job-execution-sequence control module 402 receives converted image data of the job A from the image processing server 105, and in step S512, the job A is re-promoted to a top priority position in waiting for printing. The attribute of the job A describes the job information B, C, and D that have overtaken the job A. Therefore, if these three jobs are present before the job A, the job A will be processed before the jobs B to D.

In this case, execution of the job B has been already completed, and printing for the job C has started. Therefore, the job A is placed in front of the job D present at the foremost position in a waiting cue. Further, at this moment, the job A is set to a non-overtakability state.

In this state, at a time 6, printing for the job C is completed, and printing for the job A has started.

A job like the job A utilizes the image processing server 105 and is expected to consume some time before printing for this job begins. Therefore, as described above, such a job is sequentially overtaken by subsequent jobs, and when it becomes executable, the printing for this job begins on a top priority basis.

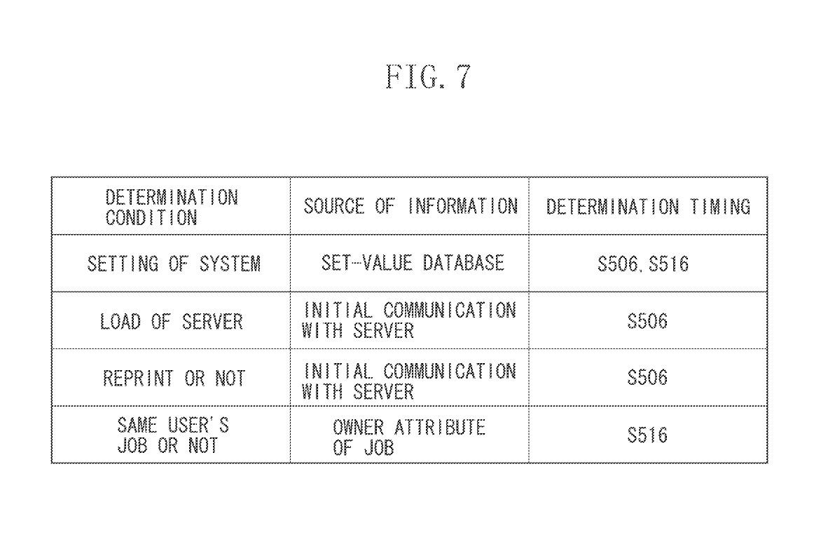

FIG. 7 is a diagram for describing a condition for changing a job execution sequence in job-sequence changing processing illustrated in FIGS. 5A and 5B. Specifically, corresponding to the condition for setting an overtakable job in step S506 of FIG. 5A, each condition will be described below in detail with reference to FIG. 7.

A first row in FIG. 7 indicates setting of a system for determining whether to perform overtaking control in the job execution sequence. Whether to perform the overtaking control may be set, for example, by a user using a control panel of the image processing apparatus.

The set-value database 409 illustrated in FIG. 4 may hold flag information indicating whether to perform the overtaking control. Whether to change the job execution sequence can be controlled from a module such as the screen control module 411, through the set-value management module 407. Therefore, in step S506, the job-execution-sequence control module 402 first refers to this control flag information. When this control flag information indicates no execution of the overtaking control, a result of determination is No in step S506.

Next, control depending on a processing load status of the image processing server 105 will be described. This control corresponds to a second row in FIG. 7. This control will be described using an example in which it is determined whether to perform job interchange control based on a status of the communication with the image processing server 105. First, the following possibility is conceivable. When the initial communication with the image processing server 105 is performed in step S505, a request to hold the processing due to an overload may be returned from the image processing server 105. In general, this may be implemented by returning an error code 503 indicating “Service Unavailable” in the communication of Hypertext Transfer Protocol (HTTP).

In this example, the image-processing-server communication module 404 resends the data and thus is expected to consume a long time before the processing target job enters a printable state. Therefore, this example corresponds to the determination condition in step S506. In other words, when the error code 503 indicating “Service Unavailable” is returned, a result of determination is Yes in step S506.

Next, an example of a reprint-use case corresponding to a third row in FIG. 7 will be described. This is an example of using a reprint-job attribute.

In this example, the following mode can be implemented. The image processing server 105 can maintain a result of processing performed once for a predetermined period of time. In this state, upon receipt of a reprinting instruction from the image processing apparatus 101, the image processing server 105 can download a converted image from the storage of the image processing server 105, and reprint the downloaded image. In this example, the image processing server 105 only performs downloading of image data, without performing conversion processing. Therefore, a waiting time of the image processing apparatus 101 can be much shorter than normal waiting time. Hence, in the example of the reprint use, a non-overtakability attribute is set to the processing target job (in other words, a result of determination is No in step S506).

Next, an example in which an owner (job owner information) of job entry is the condition will be described. This example corresponds to a fourth row in FIG. 7.

Specifically, in this example, determination is made at the timing of step S516, instead of the timing of step S506 illustrated in FIG. 5A. As described above, the flag information indicating whether to perform the overtaking control is maintained in the set-value database 409. In this example corresponding to the fourth row in FIG. 7, determination is made not only by checking the flag information at the timing of step S516, but also by checking, for example, the owner of the job entry.

Suppose the same user feeds two or more jobs successively. In this case, when a preceding job utilizes the the image processing server 105 and processing of a subsequent job can be completed in the image processing apparatus 101, it is convenient for the user not to allow the overtaking so that an entry sequence and an execution sequence are the same.

This can be implemented by performing the following control in this example. That is, even when the owner of the processing target job is the same as the owner of a preceding job, the processing target job is prevented from overtaking the preceding job (in other words, the processing sequence is maintained) in step S516.

In this case, the owner information of the job is the necessary information. This necessary information is retrieved from the authentication database 408 through the authentication module 406 and added to the job queue 410 as an attribute of the job, when the job entry module 401 feeds the job entry.

By making the determination based on the above-described conditions, interchange of jobs in the execution sequence can be controlled. The determination can be performed based on only one of the above-enumerated conditions, or on a combination of these conditions. My making the determination, print processing can be efficiently performed, even when two or more jobs are successively fed, because server resources and image-processing-apparatus resources are effectively utilized in terms of a temporal axis.

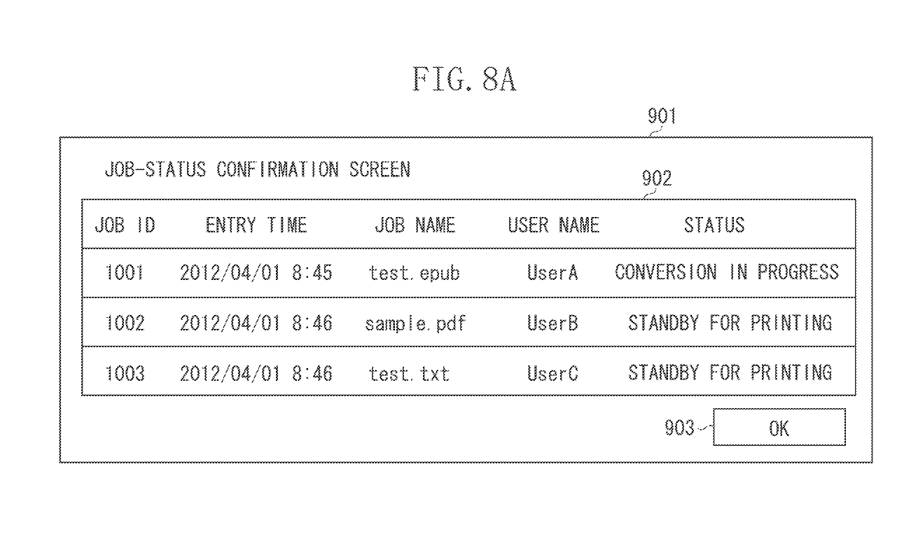

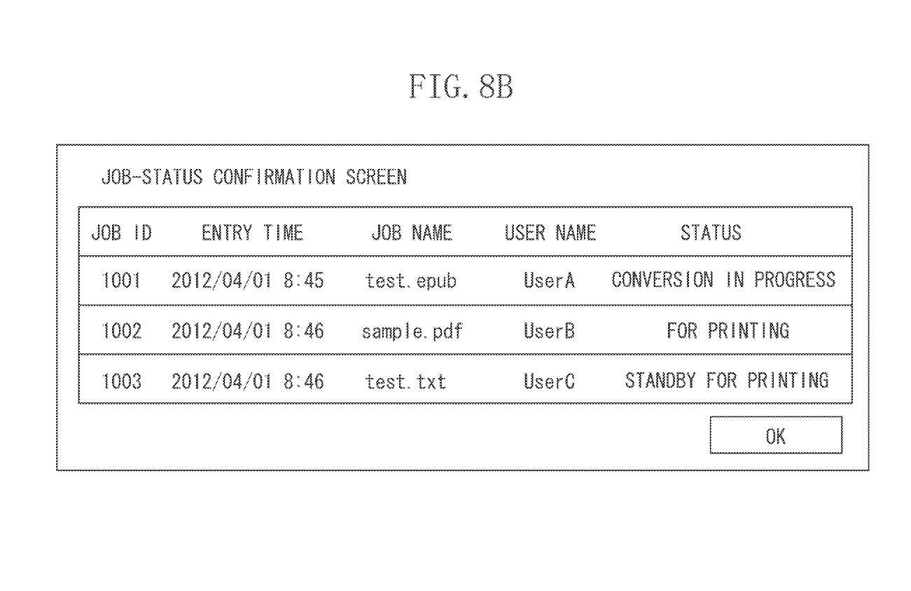

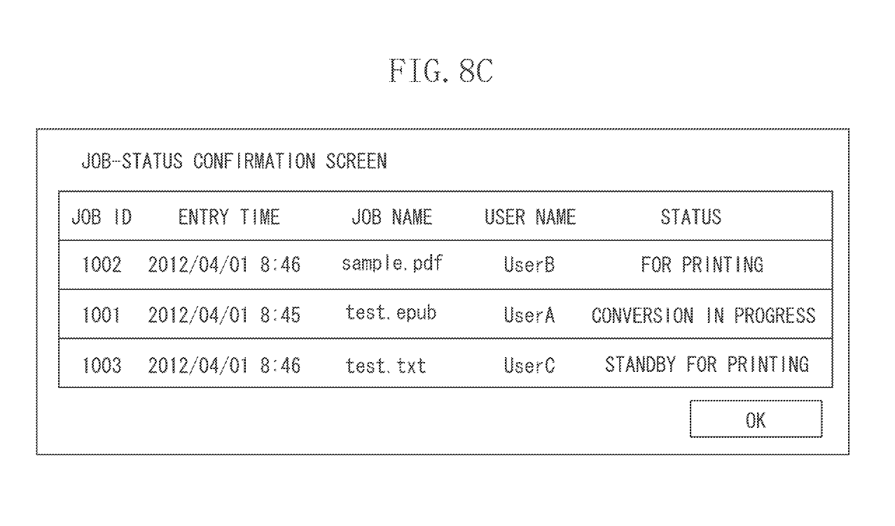

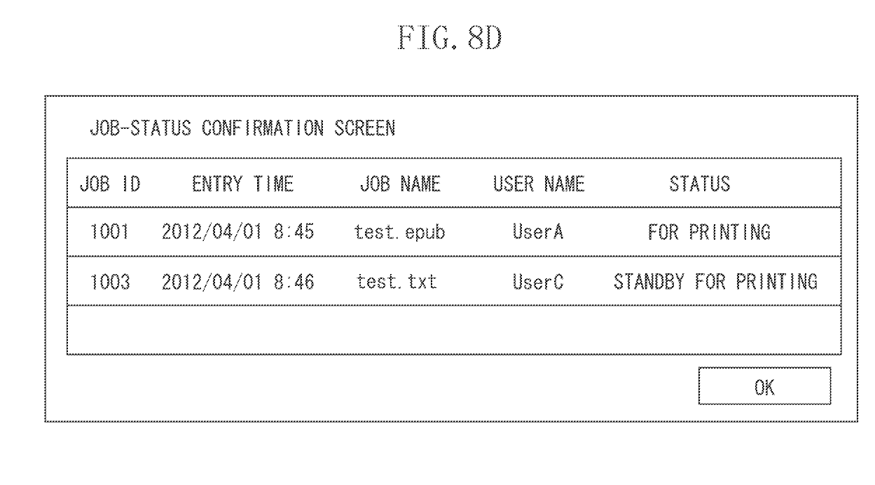

FIGS. 8A to 8D are diagrams each illustrating an example of a UI screen that can be displayed in the image processing apparatus 101 according to the present exemplary embodiment. The example illustrated in each of FIGS. 8A to 8D is a job-status confirmation screen. A case of displaying a job interchange state will be described as follows. The example illustrated in each of FIGS. 8A to 8D is a job situation screen 901 displayed on the operation unit 303 and indicating a job execution status. In the following, display control will be described. This display control is performed to display a status of interchange of jobs in an execution sequence, in the image processing apparatus 101 according to the present exemplary embodiment.

A user is allowed to confirm a status of a print job fed into a frame 902. This screen is closed when an OK button 903 is pressed by the user.

FIG. 8A illustrates a display example in which three users feed the respective print jobs almost simultaneously. In this example, a user A gives a print instruction of a file named “test.epub”, a user B gives a print instruction of a file named “sample.pdf”, and a user C gives a print instruction of a file named “test.txt”.

It is assumed that, at this moment, the jobs fed by the users A, B, and C are given identifications (IDs) “1001”, “1002”, and “1003”, respectively. In addition, only the job for printing “test.epub” of ID=1001 is assumed to utilize the image processing server 105.

Because the job with ID=1001 is the oldest in an entry sequence, processing of this job begins first. However, a request for the processing of this job is sent to the image processing server 105, and this job waits for image conversion. This job with ID=1001 is therefore defined to be overtakable, and enters a standby state. Meanwhile, processing of the job with ID=1002 is completed by the image processing module 405 in the image processing apparatus 101, and this job enters a printable state. The job with ID=1002 then overtakes the preceding job.

As a result, as illustrated in FIG. 8B, printing of the job with ID=1002 begins first.

Subsequently, when converted data of the job with ID=1001 is received from the image processing server 105, the job with ID=1001 enters a printable state. Therefore, the job with ID=1001 is promoted to a position immediately after the job with ID=1002, as illustrated in FIG. 8C. Subsequently, when the printing of the preceding job with ID=1002 is completed, a state illustrated in FIG. 8D is displayed, and printing of the job with ID=1001 is performed ahead of the job with ID=1003. An order of the jobs is thus interchanged.

Accordingly, in a case where the second data received after the first data is in a format processable by the own image processing apparatus, and the first data is being converted, print processing of the second data is executed before the first data. In other words, execution of subsequent jobs continues, until a return of a preceding job which the server apparatus is requested to process. When the preceding job is returned, this returned job is interchanged and executed as a job having a top priority among the subsequent jobs. This enables efficient processing.

Next, processing according to a second embodiment will be described. This processing is performed when a print job that utilizes the image processing server 105 is fed as a subsequent job, while a preceding print job that does not utilize the image processing server 105 is present. The basic configuration of the present exemplary embodiment is similar to that of the first exemplary embodiment and configurations similar to those in FIGS. 1 to 4 and 8 of the first exemplary embodiment will not be described.

There is a limit to the number of cases processable at a time by the image processing module 405 in the image processing apparatus 101, due to constraints such as memory capacity and hardware resources. Therefore, the preceding print job that does not utilize the image processing server 105 may be in a standby state waiting until the resources of the image processing module 405 become available.

However, in step S504, regardless of the waiting, the job-execution-sequence control module 402 requests the image processing server 105 to perform image conversion of the subsequent job that utilizes the image processing server 105. Therefore, the image processing server 105 and the image processing module 405 in the image processing apparatus 101 can perform conversion processing in parallel. Hence, processing efficiency is improved in this case as well.

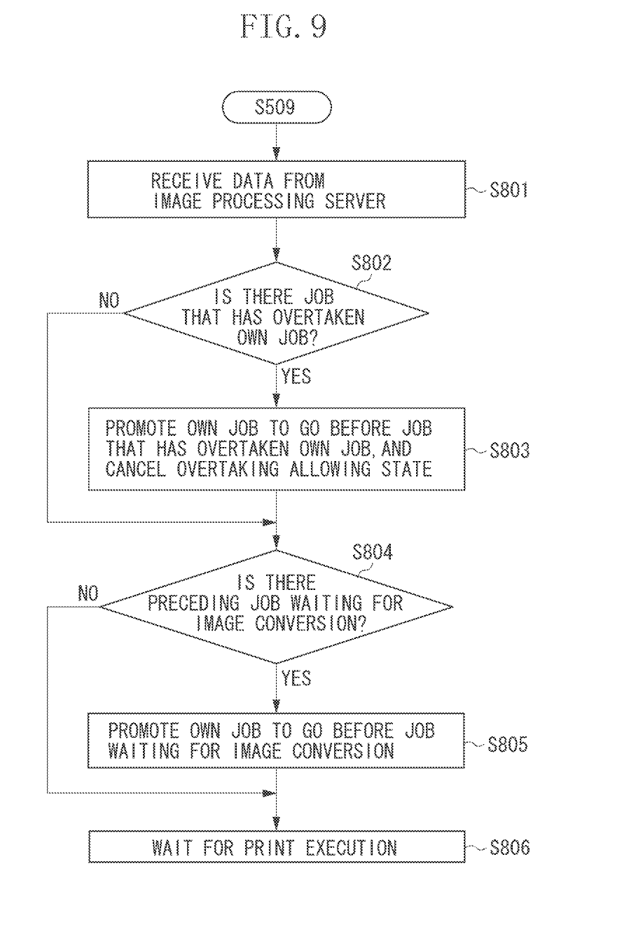

In order to use the printer resources more efficiently in such a case, determination processing in steps illustrated in FIG. 9 is additionally performed in the sequence illustrated in FIGS. 5A and 5B, in the present exemplary embodiment. Specifically, the processing following step S509 illustrated in FIG. 5A is modified.

FIG. 9 is a flowchart used to describe a method for controlling the image processing apparatus 101 according to the present exemplary embodiment. This example is execution sequence control performed by the job-execution-sequence control module 402 that is illustrated in FIG. 4 and executed by the CPU 311 illustrated in FIG. 3.

After step S509, in step S801, the job-execution-sequence control module 402 receives converted data from the image processing server 105 through the image-processing-server communication module 404. In step S802, the job-execution-sequence control module 402 determines whether a job that has overtaken the processing target job is present. If it is determined here that a job that has overtaken the processing target job is present (Yes in step S802), the job-execution-sequence control module 402 proceeds to step S803. In step S803, the job-execution-sequence control module 402 promotes the processing target job to a position immediately before the job that has overtaken the processing target job, and temporarily fixes this sequence. The processing up to this step is similar to the processing in the first exemplary embodiment.

After that, in the second exemplary embodiment, in step S804, the job-execution-sequence control module 402 determines whether a job waiting for image conversion is present before the processing target job in the image processing module 405. When the job-execution-sequence control module 402 determines here that a job waiting for image conversion is present before the processing target job (Yes in step S804), the job-execution-sequence control module 402 proceeds to step S805. In step S805, the job-execution-sequence control module 402 places the processing target job at a position before the job waiting for image conversion. Subsequently, in step S806, the job-execution-sequence control module 402 enters a printing standby state.

On the other hand, when it is determined that a job waiting for image conversion is not present before the processing target job (No in step S804), the job-execution-sequence control module 402 maintains the sequence fixed in step S803, and proceeds to step S806. In step S806, the job-execution-sequence control module 402 shifts to a printing standby state.

As a result, when the job after the image conversion utilizing the image processing server 105 is returned to the image processing apparatus 101, printing of this returned job can be started before a job in the image processing apparatus 101 which is yet to be subjected to image processing, although the job in the image processing apparatus 101 should be executed in the first place before the returned job. Thus, it can be expected to utilize the printer resources more efficiently.

A switching flag used to determine whether to execute the processing in the present exemplary embodiment is held in the set-value database 409. The job-execution-sequence control module 402 switches operation by referring to this flag. As described above, according to the exemplary embodiments, efficient print processing can be executed.

### Other Embodiments

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-148472 filed Jul. 17, 2013, which is hereby incorporated by reference herein in its entirety.

What is claimed is:

1. An image processing apparatus capable of communicating with a server that can generate print data, the image processing apparatus comprising:
a transmission unit configured to transmit first data, when the first data is in a format that cannot be processed in the image processing apparatus, to the server; and
an execution unit configured to execute print processing of second data ahead of the first data, when the second data received after the first data is in a format that can be processed in the image processing apparatus and the first data processed by the server is not received.

2. The image processing apparatus according to claim 1, wherein the first data is managed as interchangeable data when interchange of a printing-processing execution sequence is controlled.

3. The image processing apparatus according to claim 1, wherein, when owner information of the first data and owner information of the second data are the same, a processing sequence in which the first data is processed and then the second data is processed is maintained.

4. The image processing apparatus according to claim 1, wherein, when the first data is to be reprinted, a processing sequence in which the first data is processed and then the second data is processed is maintained.

5. The image processing apparatus according to claim 1, wherein, based on a communication state with the server, the print processing execution unit determines whether to execute the print processing of the second data ahead of the first data.

6. The image processing apparatus according to claim 1, further comprising a display control unit configured to display a processing sequence of the first and the second data.

7. A method for controlling an image processing apparatus capable of communicating with a server that can generate print data, the method comprising:
transmitting first data to the server when the first data is in a format that cannot be processed in the image processing apparatus; and
executing print processing of second data ahead of the first data when the second data received after the first data is in a format that cannot be processed in the image processing apparatus and the first data processed by the server is not received.

8. The method for controlling the image processing apparatus according to claim 7, wherein, when interchange of a print-processing execution sequence is controlled, the first data is managed as interchangeable data.

9. The method for controlling the image processing apparatus according to claim 7, wherein, when owner information of the first data and owner information of the second data are the same, a processing sequence in which the first data is processed and then the second data is processed is maintained.

10. The method for controlling the image processing apparatus according to claim 7, wherein, when the first data is to be reprinted, a processing sequence in which the first data is processed and then the second data is processed is maintained.

11. The method for controlling the image processing apparatus according to claim 7, wherein in the print execution processing, it is determined, based on a communication state with the server, whether to execute the print processing of the second data ahead of the first data.

12. The method for controlling the image processing apparatus according to claim 7, further comprising controlling display of a processing sequence of the first and the second data.

13. A computer-readable storage medium storing computer executable instructions that cause a computer to execute a method, the method comprising:
transmitting first data to the server when the first data is in a format that cannot be processed in the image processing apparatus; and
executing print processing of second data ahead of the first data when the second data received after the first data is in a format that cannot be processed in the image processing apparatus and the first data processed by the server is not received.
